(19) United States
(12) Patent Application Publication
(10) Pub. No.: US 2021/0207572 A1
(43) Pub. Date: Jul. 8, 2021

(54) BUOYANT COUNTERBALANCE SYSTEM AND METHOD FOR USING SAME

(71) Applicant: Wayne S. Travis, Oklahoma City, OK (US)

(72) Inventor: Wayne S. Travis, Oklahoma City, OK (US)

(21) Appl. No.: 17/096,328

(22) Filed: Nov. 12, 2020

Related U.S. Application Data
(60) Provisional application No. 62/957,368, filed on Jan. 6, 2020.

(51) Int. Cl. F03B 17/02

(52) U.S. Cl. CPC F03B 17/02

(57) ABSTRACT

A buoyant counterbalance system and method for using same utilizing a pair of units in fluid communication with each other. Each unit including a tank configured to slidably receive a production ram slidably. A displacement member in a fixed position in relation to the tank and production ram. The displacement member located in the production ram, and defining a first channel including a first piston, and a second channel in communication with an interior of the production ram. A hollow pedestal connected to both of the displacement members, and is configured to communicate a fluid between them. A production line connects to a first side each of the pistons.

### CROSS-REFERENCE TO RELATED APPLICATION

This application claims the benefit of priority under 35 U.S.C. § 119(e) based upon co-pending U.S. provisional patent application Ser. No. 62/957,368 filed on Jan. 6, 2020. The entire disclosure of the prior provisional application is incorporated herein by reference.

### BACKGROUND

### Technical Field

The present technology generally relates to a buoyant counterbalance system and method for using the same for use in connection with utilizing counterbalancing buoyancy forces to create gravitational potential and then work performed, and to a method of using the same. More particularly, but not by way of limitation, the present technology herein relate to an apparatus for utilizing buoyancy forces displacement in a body liquid is shared between multiple tanks, and to a method of using the same.

### Background Description

The properties of buoyancy have been explored as a source of renewable or “green” energy because of the ability to use buoyancy forces in existing bodies of water without generating additional environmental pollution and greenhouse gases.

Known buoyancy devices typically depend on utilizing the buoyancy energy of waves, or moving waters, and as such have limited applications, as they must be installed at certain locations where waves or moving waters are available in order to work. Further, such prior art devices do not produce a consistent level of power, as the power output of such prior art devices is subject to fluctuations in waves, tides, and to seasonal water level variations.

Another problem with currently existing buoyancy devices is that they are often complicated apparatuses with multiple components, which require frequent maintenance and replacement, and are expensive to implement and operate. Further, such complicated devices often suffer from low efficiency and are generally unreliable due to their overly complicated designs.

However, these known buoyancy devices have many disadvantages, such as but not limited to, untimely, costly to manufacture and/or operate, degrading, unreliable energy production from current alternative energy sources and the added cost of energy storage.

While the above-described devices fulfill their respective, particular objectives and requirements, the aforementioned patents do not describe a buoyant counterbalance system and method for using the same that allows utilizing buoyancy forces displacement in a body liquid that can be shared between multiple tanks.

Therefore, a need exists for a new and novel buoyant counterbalance system and method for using the same that can be used for utilizing buoyancy forces displacement in a body liquid that can be shared between multiple tanks. In this regard, the present technology substantially fulfills this need. In this respect, the buoyant counterbalance system and method for using same according to the present technology substantially departs from the conventional concepts and designs of the prior art, and in doing so provides an apparatus primarily developed for the purpose of utilizing buoyancy forces displacement in a body liquid that can be shared between multiple tanks.

### BRIEF SUMMARY OF THE PRESENT TECHNOLOGY

In view of the foregoing disadvantages inherent in the known types of buoyancy devices now present in the prior art, the present technology provides a novel buoyant counterbalance system and method for using same, and overcomes the above-mentioned disadvantages and drawbacks of the prior art. As such, the general purpose of the present technology, which will be described subsequently in greater detail, is to provide a new and novel buoyant counterbalance system and method for using same and method which has all the advantages of the prior art mentioned heretofore and many novel features that result in a buoyant counterbalance system and method for using same which is not anticipated, rendered obvious, suggested, or even implied by the prior art, either alone or in any combination thereof.

According to one, the present technology can include a fluid counterbalance system including a first unit and a second unit. The first unit can include a first tank having a top wall, a bottom wall and a sidewall. A first production ram can be slidably receivable in the first tank. The first production ram can have a top wall, an open bottom and a sidewall. A first displacement member can be in a fixed position in relation to the first tank and the first production ram. The first displacement member can be located in the production ram. The first displacement member can define a first channel including a first piston, and a second channel offset from the first channel and in communication with an interior of the first production ram. The second unit can include a second tank having a top wall, a bottom wall and a sidewall. A second production ram can be slidably receivable in the second tank. The second production ram can have a top wall, an open bottom and a sidewall. A second displacement member can be in a fixed position in relation to the second tank and the second production ram. The second displacement member can be located in the second production ram. The second displacement member can define a first channel including a second piston, and a second channel offset from the first channel and in communication with an interior of the second production ram. A hollow pedestal can be connected to the first displacement member and the second displacement member. The hollow pedestal can be configured to communicate a fluid between the interior of the first production ram and the interior of the second production ram. A production line can be connected to a first side of the first piston and a first side of the second piston.

According to another aspect, the present technology can include a fluid counterbalance system including a first unit and a second unit each being vertically moveable in opposite directions directly based each other's movement. The first unit can include a first tank configured to be vertically moveable. A first production ram can be slidably receivable in the first tank. The first production ram can include a top wall, an open bottom, a sidewall and a first production piston. A first displacement member can be in a fixed position in relation to the first tank and the first production ram. The first displacement member can be located in the first production ram. The first displacement member can include a first production cylinder configured to slidably receive the first production piston to vertically move the first production ram when a displacement fluid is provided thereto or removed therefrom by way of a first production line. The second unit can include a second tank configured to be vertically moveable. A second production ram can be slidably receivable in the second tank. The second production ram can include a top wall, an open bottom, a sidewall and a second production piston. A second displacement member can be in a fixed position in relation to the second tank and the second production ram. The second displacement member can be located in the second production ram. The second displacement member can include a second production cylinder configured to slidably receive the second production piston to vertically move the second production ram when the displacement fluid is provided thereto or removed therefrom by way of a second production line. A hollow pedestal can be connected to the first displacement member and the second displacement member. The hollow pedestal can be configured to communicate a production fluid between an interior of the first production ram and an interior of the second production ram. A directional control valve can be configured to control the displacement fluid to or from the first production cylinder, and the second production cylinder. A counterbalance assembly can be located below each of the first and second tanks, and configured to opposingly raise or lower the first and second tanks, respectively.

According to still another aspect, the present technology can include a method of using a fluid counterbalance system. The method can include the steps of creating a height displacement and a pressure difference between a first tank and a second tank by alternating lowering the first tank and raising the second tank that is directly based on movement of the first tank. Moving a first production ram about a first displacement member in a fixed position in the first tank, and moving a second production ram about a second displacement member in a fixed position in the second tank in a direction opposite to that of the first production ram by transferring a fluid between an interior of the first production ram and an interior of the second production ram. The first and second displacement members can be in a fixed position by a hollow pedestal attached thereto, and the fluid can be transferred between the first and second production rams by way of the hollow pedestal. Remaining the first tank and the second tank in an unbalanced condition. Providing a first counterbalance to the first tank and a second counter balance to the second tank that is opposite to the first counterbalance.

There has thus been outlined, rather broadly, features of the present technology in order that the detailed description thereof that follows may be better understood and in order that the present contribution to the art may be better appreciated.

In some or all embodiments, the first tank and the second tank can each include a fluid driven cylinder configured to raise or lower the first tank and the second tank, respectively.

Some or all embodiments can include a directional control valve.

In some or all embodiments, the fluid drive cylinder of the first tank and the second tank can be connected to the directional control valve.

Some or all embodiments can include a fluid reservoir connected to the directional control valve.

Some or all embodiments can include an accumulator connected to the directional control valve.

Some or all embodiments can include a fluid motor configured to receive fluid from the directional control valve.

Some or all embodiments can include an electric generator connected to the fluid motor.

Some or all embodiments can include a first displacement conduit configured to communicate a displacement fluid to or from the first piston, and a second displacement conduit configured to communicate the displacement fluid to or from the second piston by way of the directional control valve. At least a part of the first and second displacement conduits can be provided in the hollow pedestal.

In some or all embodiments, the first and second units can each include a fluid filled counter balance tank including a buoyant float slidably received therein and connected to the first tank and the second tank, respectively.

In some or all embodiments, the first and second units can each include counterbalance fluid driven cylinder and piston assembly configured to opposingly raise or lower the first and second units, respectively, by way of a shared counterbalance fluid.

Some or all embodiments can include a connection line connecting a first end of each of the fluid driven cylinder and piston assemblies to each other.

Some or all embodiments can include a pump connected to the connection line.

Some or all embodiments can include an air connection conduit attached to the top wall of the first and second tanks. The air connection conduit can be configured to communicate any air or gas between an upper zone of the first and second tanks.

In some or all embodiments, the directional control valve can be connected with and configured to provide or receive the displacement fluid to or from a fluid reservoir, an accumulator connected, and a fluid motor connected to an electric generator.

Some or all embodiments can include a first displacement conduit configured to communicate the displacement fluid to or from the first production cylinder, and a second displacement conduit configured to communicate the displacement fluid to or from the second production cylinder by way of the directional control valve. At least a part of the first and second displacement conduits are provided in the hollow pedestal.

In some or all embodiments, the counterbalance assembly can be a fluid filled counter balance tank including a buoyant float slidably received therein and connected to the first tank and the second tank, respectively. The present technology can further include a first actuator configured to raise or lower the first tank and a second actuator configured to raise or lower the second tank. The first and second actuators can be controlled by communication of the displacement fluid controlled from the directional control valve.

In some or all embodiments, the counterbalance assembly can be a pair of counterbalance cylinder and piston assemblies configured to opposingly raise or lower the firs counterbalance cylinder and piston assemblies by a pump connected to a connection line connecting the counterbalance cylinder and piston assemblies to each other.

Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology. It is, therefore, that the claims be regarded as including such equivalent constructions insofar as they do not depart from the spirit and scope of the present technology.

It is therefore an object of the present technology to provide a new and novel buoyant counterbalance system and method for using same that has all of the advantages of the prior art buoyancy devices and none of the disadvantages.

It is another object of the present technology to provide a new and novel buoyant counterbalance system and method for using same that may be easily and efficiently manufactured and marketed.

An even further object of the present technology is to provide a new and novel buoyant counterbalance system and method for using same that has a low cost of manufacture with regard to both materials and labor, and which accordingly is then susceptible of low prices of sale to the consuming public, thereby making such buoyant counterbalance system and method for using same economically available to the buying public.

Still another object of the present technology is to provide a new buoyant counterbalance system and method for using same that provides in the apparatuses and methods of the prior art some of the advantages thereof, while simultaneously overcoming some of the disadvantages normally associated therewith.

Even still another object of the present technology is to provide a buoyant counterbalance system and method for using same for utilizing buoyancy forces displacement in a body liquid that can be shared between multiple tanks.

These together with other objects of the present technology, along with the various features of novelty that characterize the present technology, are pointed out with particularity in the claims annexed to and forming a part of this disclosure. For a better understanding of the present technology, its operating advantages and the specific objects attained by its uses, reference should be made to the accompanying drawings and descriptive matter in which there are illustrated embodiments of the present technology.

### DETAILED DESCRIPTION OF THE DRAWINGS

The present technology will be better understood and objects other than those set forth above will become apparent when consideration is given to the following detailed description thereof. Such description makes reference to the annexed drawings wherein:

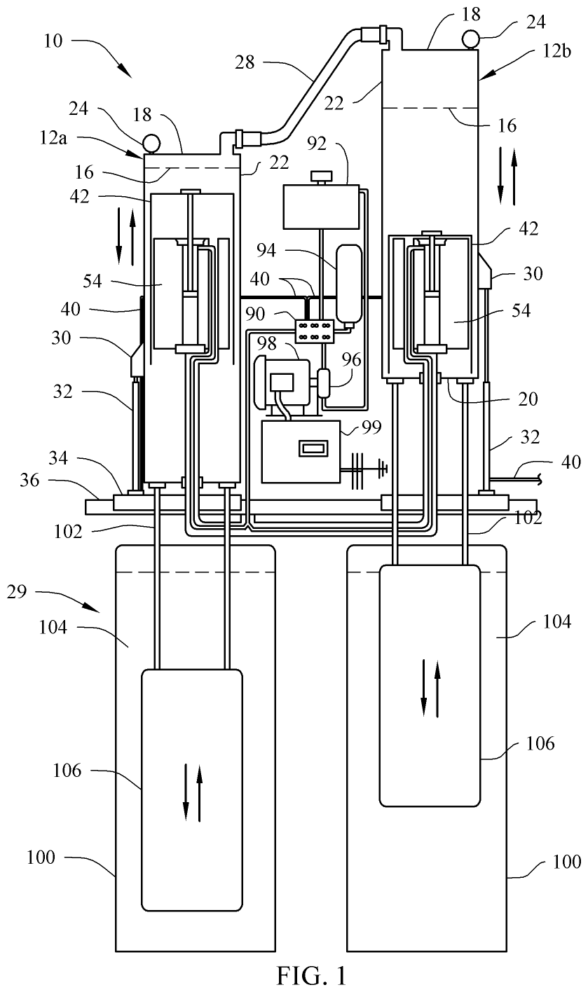

FIG. 1 is a cross-sectional schematic view of an embodiment of the buoyant counterbalance system and method for using same constructed in accordance with the principles of the present technology.

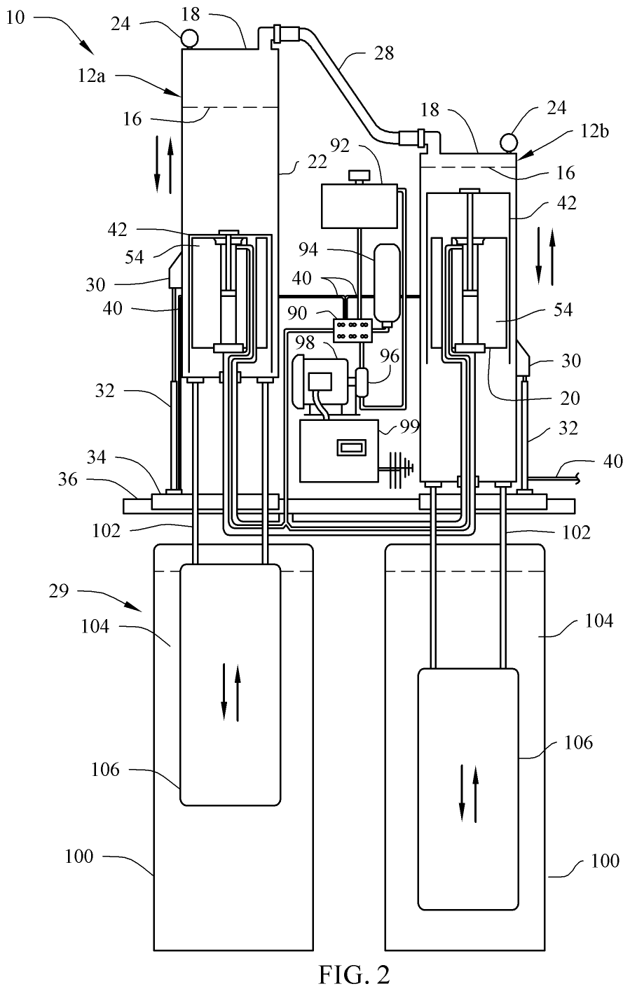

FIG. 2 is a cross-sectional schematic view of the present technology with the units in opposite positions.

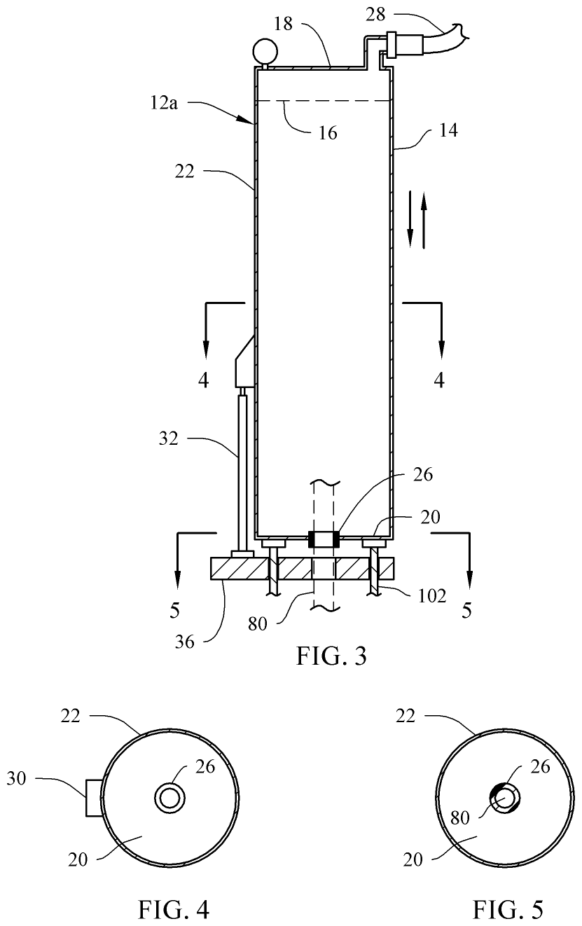

FIG. 3 is a cross-sectional view of one of the primary tanks of the present technology.

FIG. 4 is a cross-sectional view of the primary tank taken along line 4-4 in FIG. 3.

FIG. 5 is a cross-sectional view of the seal of the primary tank taken along line 5-5 in FIG. 3.

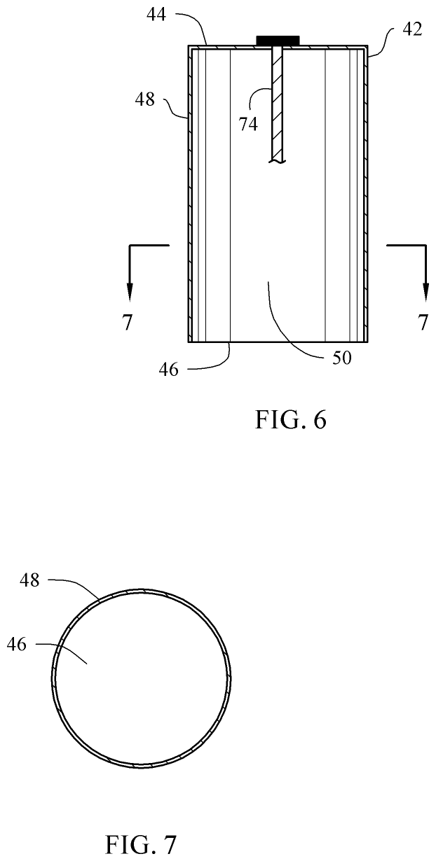

FIG. 6 is a cross-sectional view of production ram of the present technology.

FIG. 7 is a cross-sectional view of the production ram taken along line 6-6 in FIG. 6.

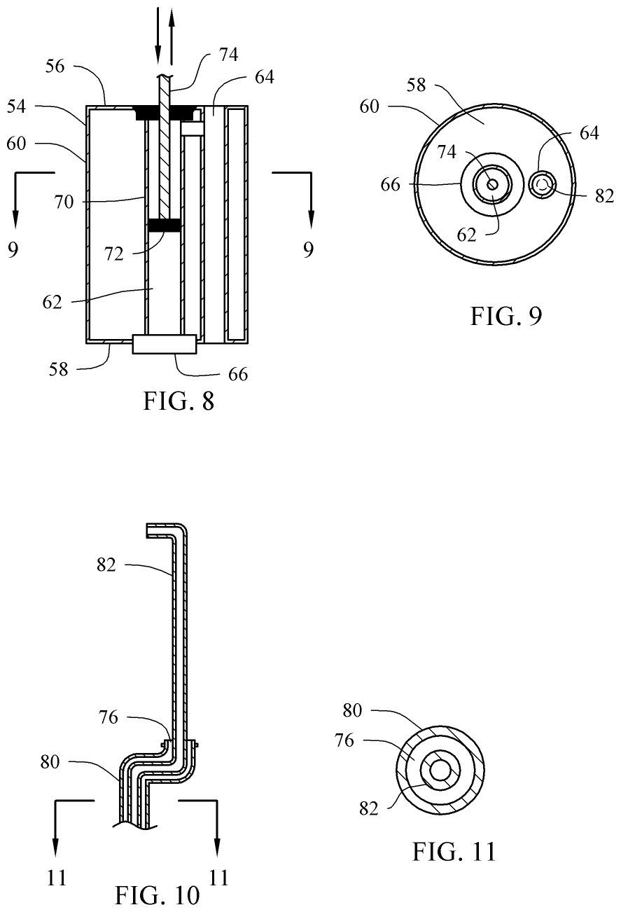

FIG. 8 is a cross-sectional view of the fixed displacement member of the present technology.

FIG. 9 is a cross-sectional view of the fixed displacement member taken along line 9-9 in FIG. 8.

FIG. 10 is a cross-sectional view of the production line/fluid and the displacement conduit or hose of the present technology.

FIG. 11 is a cross-sectional view of the production line/fluid and the displacement conduit or hose taken along line 11-11 in FIG. 10.

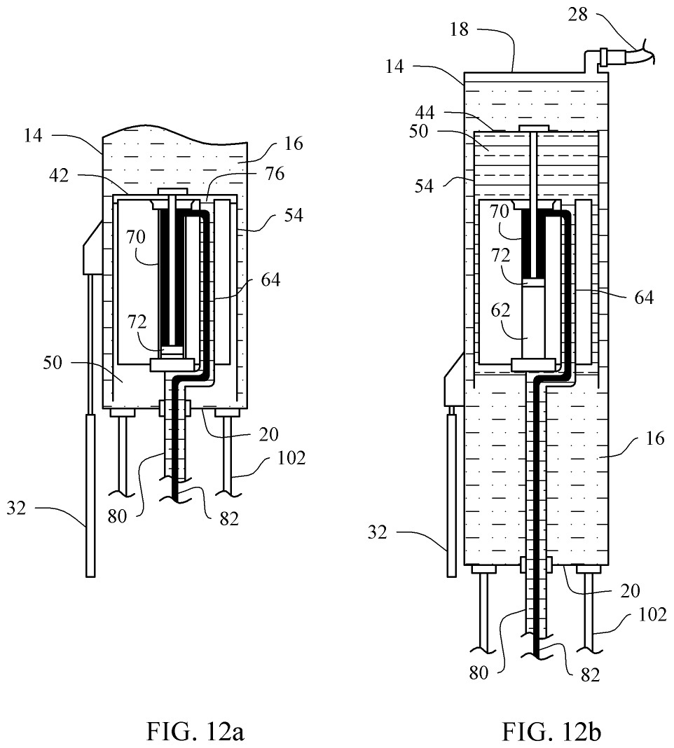

FIGS. 12a-b are cross-sectional schematic views of the production ram and the primary tank in different vertical positions including their respective fluid flow.

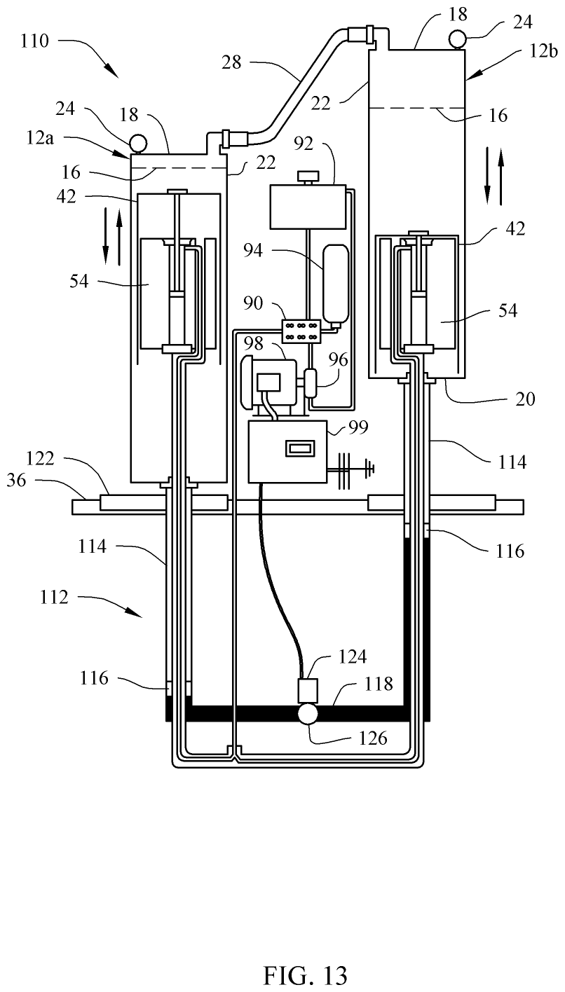

FIG. 13 is a cross-sectional schematic view of the alternate embodiment system of the present technology.

The same reference numerals refer to the same parts throughout the various figures.

### DETAILED DESCRIPTION OF THE PRESENT TECHNOLOGY

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. The inventive concepts disclosed herein are capable of other embodiments or of being practiced or carried out in various ways. Also, it is to be understood that the phraseology and terminology employed herein is for the purpose of description only and should not be regarded as limiting the inventive concepts disclosed and claimed herein in any way, unless expressly stated to the contrary.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features have not been described in detail to avoid unnecessarily complicating the instant disclosure.

As used herein the notation “a-n” appended to a reference numeral is intended as merely convenient shorthand to reference one, or more than one, and up to infinity, of the element or feature identified by the respective reference numeral (e.g., 10a-n). Similarly, a letter following a reference numeral is intended to reference an embodiment of the feature or element that may be similar, but not necessarily identical, to a previously described element or feature bearing the same reference numeral (e.g., 10, 10a, 10b, etc.). Such shorthand notations are used for purposes of clarity and convenience only, and should not be construed to limit the instant inventive concepts in any way, unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Referring now to the drawings, and particularly to FIGS. 1-13, an exemplary embodiment of the buoyant counterbalance system and method for using same of the present technology is shown and generally designated by the reference numeral 10.

In FIGS. 1 and 2, a new and novel buoyant counterbalance system 10 of the present technology for utilizing buoyancy forces displacement in a body liquid that can be shared between multiple tanks is illustrated and will be described. The apparatus or system 10 comprises two units 12a and 12b connected by a hydraulic balance assembly, circuit or system 29. Each unit 12a, 12b can include a primary tank 14, a production pod or ram 42, a fixed displacement member or unit 54 connected to a hydraulic capture system 29, a production capture cylinder 70, and a counter balance tank 100. The primary tank 14 is at least partially filled with a liquid 16, and the counter balance tank 100 is at least partially filled with a counter balance liquid or fluid 104, as will be described herein below.

The two units 12a and 12b are substantially identical in structure and function, and can be mirror images of each other. Therefore, only the unit 12a will be described in detail herein.

Referring to FIGS. 3-5, each of the primary tanks 14 can be any primary tank capable of containing a liquid 16, such as water or other suitable liquid. The primary tank 14 may be of any suitable size and shape, but is shown substantially cylindrical in shape, and has a closed top end 18, a substantially flat horizontal bottom 20, and substantially vertically extending cylindrical tank sidewall 22. In some embodiments, the tank sidewall 22 may comprise more than one concentric portion. The primary tank 14 can be made from steel or other non-corrosive material of sufficient strength and durability, for example. The primary tank 14 may include a pressure gage 24 associated with the closed top end 18. In the alternative, the closed top end 18 may be a lid that is lockable to prevent unauthorized access to the inside of the primary tank 14. Additionally, the primary tank 14 may comprise insulation, heating and/or cooling means, a drain valve, and a fill valve, for example.

The bottom 20 of the primary tank 14 includes a sealed opening 26 that seals and moveably receives a fixed pedestal 80 therethrough. The opening 26 allows for the primary tank 14 to travel along a length of the pedestal 80, while sealing thereagainst to prevent liquid 16 from leaking.

An air connection conduit or hose 28 can be attached to a port associated with the closed top end 18 of the primary tank 14 of each of the units 12a, 12b. The hose 28 can be configured to communicate air between an upper section of the primary tank 14 of each of the units 12a, 12b. The hose 28 is flexible and can be made of any suitable material, as best illustrated in FIG. 5.

The primary tank 14 may be stationary, or mounted on a movable platform (not shown) such as a land-based vehicle, a water-based vehicle, or an air-based vehicle, for example. The liquid 16 contained inside the primary tank 14 may be any liquid, such as tap water, distilled water, seawater, lake water, mineral oil, motor oil, and combinations thereof, and may comprise any number of chemical additives such as salts and/or pH buffers, depending on the environmental variables at the primary tank 14 location, and the material of choice for the primary tank 14 and the system 10. In a non-limiting example, the liquid 16 used in an primary tank 14 facing extremely low temperatures may comprise ethylene glycol, water and ethylene glycol in various proportions, or other anti-freezing agents, in order to protect the liquid 16 from freezing. Additionally, the liquid 16 inside the primary tank 14 may be treated with bactericidal agents and/or other chemical or biological agents to prevent the growth of unwanted organisms, for example.

It is to be understood that the two primary tanks 14 housing the two units 12a and 12b may have different shapes and sizes, may be made of different materials, and may contain different liquids, for example.

The primary tanks 14 can include a drive system mount 30 connected to the sidewall 22 of the primary tank 14. A drive actuator or cylinder 32 can be supported by or mounted to a drive cylinder mount 34, and which includes a drive piston connectable to the drive system mount 30. The drive cylinder mount 34 can be supported by a base 36. The drive cylinder 32 can be driven by hydraulic, electrical or mechanical means. In the exemplary, the present technology can utilize a drive system 40 configured to provide or control hydraulic fluid to the drive cylinder 32 to vertically move or displace the primary tank 14 via the drive system mount 30.

As best illustrated in FIGS. 1 and 2, each of the units 12a, 12b can be vertically moved independently, so that one of the primary tanks 14 is raised while the other primary tank 14 is lowered, thereby creating a height displacement between the unites 12a, 12b.

Referring now to FIGS. 6-7, the production ram 42 is substantially cylindrical in shape, has a closed top end 44, an open bottom end 46, and a cylindrical sidewall 48 configured to define a substantially cylindrical displacement chamber 50. The production ram 42 is configured to be moveably received inside the primary tank 14, and to freely travel along a longitudinal length therein. The displacement chamber 50 is configured to receive a volume of gas or liquid.

The production ram 42 can be adapted to be lowered or submerged into the primary tank 14 such that the production ram 42 is movable in a substantially vertical direction relative to the sidewall 22 and the primary tank 14. Bumper pads (not shown) may be attached to the production ram 42 or an inner surface of the sidewall 22.

The size of the production ram 42 may vary dependent upon the output needs of the system 10. The volume or air injected into the production ram 42 and the structural integrity of the production ram 42 are matched to the safety parameters of the pressure involved with each system 10. The production ram 42 can be internally pressurized to neutralize the possibility of implosions. A volume of pressurized gas may be sealed into a closed chamber (not shown) defined in the production ram 42.

The production ram 42 may be made of any suitable material having the desired structural strength and weight, such as stainless steel, polycarbonate, plastic, fiberglass, epoxy resin, and aluminum, for example.

The function of the production ram 42 or the production ram 42 may be configured to perform the function of: (a) provide lift; (b) provide fluid or pressure balance between the units 12a, 12b; (c) provide pressure to any air or gases in the upper part of the primary tank 14; (d) support the pre-charge function; (e) to maintain pre-charge during apparatus stroke; (f) to eliminate the need for additional gap air during cycle; (g) to serve as an open chamber where compressed air can replace liquid 16; (h) to serve as a chamber where compressed liquid 16 can replace air; (i) the specific dimensions of the production ram 42 are determining for stroke length and inner riser configuration.

Referring to FIGS. 8-9, the fixed displacement unit 54 is substantially cylindrical in shape and includes an upper end 56, a lower end 58 and a cylindrical sidewall 60, defines a cylindrical first space 62 centrally located along a longitudinal axis and/or length of the fixed displacement unit 54, and defines a second cylindrical space 64 offset from the first space 62 and along the longitudinal axis and/or length of the fixed displacement unit 54.

The fixed displacement unit 54 is configured to be received inside the displacement chamber 50 of the production ram 42, and is further configured to allow the production ram 42 to vertically travel. The size of the displacement unit 54 may vary dependent upon the output needs of the system 10.

The first space 62 is configured to receive or provide the production capture cylinder 70, which includes a production capture piston 72 and production capture rod 74 connected to the production capture piston 72. The production capture piston 72 is configured to travel within the production capture cylinder 70, thereby moving the production capture rod 74 in a vertical direction.

An end of the production capture rod 74 is connected to the closed top end 44 of the production ram 42. Additionally, the upper end 56 can include a seal 68 configured to receive the production capture rod 74 and allow the production capture rod 74 to freely travel therethrough. A production cylinder chamber is defined between the production capture piston 72 and the seal 68. Consequently, the production ram 42 can vertically move in relation with movement of the production capture rod 74, or the production capture rod 74 can vertically move in relation with movement of the production ram 42.

The lower end 58 includes a mount 66 for mounting to an end of the pedestal 80, thereby fixing the fixed displacement unit 54 in a stationary position within the primary tank 14.

The second space 64 is configured to communicate a production line/fluid 76 from the pedestal 80 to and/or from the displacement chamber 50 of the production ram 42. The production ram 42 can be vertically displaced upon receiving of production fluid 76 from the second space 64.

Referring to FIGS. 10-11, the pedestal 80 can be fixed in relation to the base 36, and can be hollow to receive and/or communicate the production fluid 76 between the displacement chambers 50 of the production ram 42 of each of the units 12a, 12b.

A displacement conduit or hose 82 can be provided in the hollow space of the pedestal 80 to communicate a displacement fluid from, to and/or between the production cylinder chambers of the drive cylinder 32 of each of the units 12a, 12b. The displacement hose 82 is further in communication with a directional control valve 90 that is configured to control the amount and/or flow of the displacement fluid to, from and/or between the production cylinder chambers of the production cylinder/ram 42 and/or the drive cylinders 32. The displacement hose 82 can be concentrically positioned in the pedestal 80 to create an annulus configured to flow the production fluid 76.

A hydraulic reservoir 92 is configured to hold fluid for utilization with the system 10. The hydraulic reservoir 92 is in fluid communication with the directional control valve 90 that controls the flow of fluid to each of the components in the system 10. A valve and/or coupling (not shown) can be used to control the flow from the reservoir 92 to the directional control valve 90.

A hydraulic production accumulator 94 can be in fluid communication with the directional control valve 90. The production accumulator 94 can be configured such that a volume of hydraulic fluid is movable into the hydraulic accumulator by the directional control valve 90. A valve and/or coupling (not shown) can be used to control the flow from the directional control valve 90 to the accumulator 94.

A hydraulic turbine or motor 96 can be in fluid communication with the directional control valve 90 and a top portion of the reservoir 92. The motor 96 can be configured to provide torque or mechanical power to a shaft by receiving a flow of the hydraulic fluid from the directional control valve 90, which then exhausts the flow to the reservoir 92. The shaft can be coupled to a generator 98 to create electricity that can then be provided to inverter or control box 99. The electricity from the generator 98 can be utilized by components of the system 10, to other devices or power grids.

The hydraulic motor 96 of the generator 98 may be fluidly connected to the hydraulic accumulator 94 and may generate mechanical or electrical energy by using pressurized hydraulic fluid from the hydraulic accumulator 94

Connected to the horizontal bottom 20 of the primary tank 14 are one or more counter weight connecting rods 102 that may slidingly pass through the cylinder mount 34 and/or the base 36.

At a height below the primary tank 14 is a counter balance tank 100 that contains a counter balance fluid 104. The counter balance tank 100 can be fixed in relation to the base 36. The connecting rods 102 can further slidingly pass through an upper end of the counter balance tank 100. A buoyant counter balance float 106 can be provided inside the counter balance tank 100, with the connecting rods 102 being connected to the float 106. It can be appreciated that vertical movement of the primary tank 14 will translate to vertical movement of the connecting rods 102 and consequently will translate to vertical movement of the float 106, as best illustrated in FIGS. 2, 12a and 12b.

It can further be appreciated that the buoyant nature of the float 106 can cause the float 106 to rise in the counter balance fluid 104 within the counter balance tank 100, thereby vertically moving the connecting rods 102, and consequently vertically moving the primary tank 14. This vertical movement of the primary tank 14 could further move the drive cylinder 32 thereby withdrawing fluid from the second drive cylinder 32 of the other primary tank 14, which could result in retracting of the second drive cylinder 32 and consequently lowering that primary tank.

Referring to FIG. 13, an alternate embodiment system 110 of the present technology will be described. The alternate system 110 includes all the components of the above system 10, excluding the drive system mount and cylinder, the counter balance tank, connecting rods, and float. In place thereof, the alternate system 110 includes a hydraulic balancing means 112.

The alternate system 110 can include one or more units 12a, 12b, with each unit including a hydraulic cylinder shaft 114 connected to the horizontal bottom 20 of the primary tank 14. The hydraulic cylinder shaft 112 passes through the base 36 via a hydraulic cylinder mount 122. Each hydraulic cylinder shaft 114 includes a piston 116 that is configured to slide within the hydraulic cylinder shaft 114 or is integral with the hydraulic cylinder shaft 114 allow it to move in a vertical direction. A connection line 118 connects a bottom of each hydraulic cylinder shaft 114 to create a hydraulic fluid chamber 118 between the piston 116 of each hydraulic cylinder shaft 114. This hydraulic fluid chamber 118 can contain a connected hydraulic fluid.

An electric motor 124 can be in communication with and powered by the inverter or control box 99. A hydraulic pump 126 can be coupled to or associated with the connection line 118 to pump the connected hydraulic fluid in either direction, thereby providing a pulling or pushing force to each of the pistons 116 consequently moving one of the hydraulic cylinder shafts 114 vertically up while moving the other hydraulic cylinder shaft 114 down, respectively. The hydraulic pump 126 can be driven by the motor 124.

The system, process and/or method of the present technology can include at least one computer configured or configurable for automated and/or controlling operations of any of the components in the system 10, 110. The computer system can include one or more processors, memory, input and output device, display, and communication systems for transmitted and receiving data, along with sensors to monitor flow rate, volume level, particle size, temperature, pressure, vibration, energy or power consumption, energy or power generation, environmental conditions, material composition, and the like.

The computer system (not shown) can include a processor or multiple processors (e.g., CPU, GPU, or both), and a main memory and/or static memory, which communicate with each other via a bus. In other embodiments, the computer system may further include a video display (e.g., a liquid crystal display (LCD)). The computer system may also include an alpha-numeric input device(s) (e.g., a keyboard), a cursor control device (e.g., a mouse), a voice recognition or biometric verification unit (not shown), a drive unit (also referred to as disk drive unit), a signal generation device (e.g., a speaker), a universal serial bus (USB) and/or other peripheral connection, and a network interface device. In other embodiments, the computer system may further include a data encryption module (not shown) to encrypt data.

The computer system can include module(s) operably associated with the drive unit, with the drive unit including a computer or machine-readable medium on which is stored one or more sets of instructions and data structures (e.g., instructions) embodying or utilizing any one or more of the methodologies or functions described herein. The instructions may also reside, completely or at least partially, within the memory and/or within the processors during execution thereof by the computer system. The memory and the processors may also constitute machine-readable media.

The instructions may further be transmitted or received over a network via the network interface device utilizing any one of a number of well-known transfer protocols (e.g., Extensible Markup Language (XML)). While the machine-readable medium is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the device and that causes the device to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

The theory of operation of the present technology can involve a complex “process” in order to create gravitational potential and then work performed. Some aspects of the present technology can include:

Where a displacement in a body liquid is shared between two primary tanks 14.

Where the displacement containment does not travel with the primary tanks 14.

Where the primary tanks 14 travel vertically in opposite directions.

Where the elevation difference between the primary tanks 14 cause a pressure difference.

Where the displacement naturally moves to the primary tank 14 with lower pressure.

Where the displacement results in a pressure differential inside the containment.

Where the pedestal 80 is not attached to the primary tanks 14.

Where the primary tanks 14 remain balanced with each other throughout the process.

Where counter balance is attained in various methods—hydraulically, buoyantly, counter weights, etc.

Where the differential pressure acts upon the containment and displacer and not the primary tanks 14.

Where that differential causes upward and down ward force. Where that force is used to do work. Where that work is converted hydraulically and stored.

Where the opposite tank has reduced pressure differential and sinks due to its weight.

Where the opposite side production cylinder/ram 42 is refilled by the reservoir 92.

Where the directional control valve 90 causes change a change in vertical direction of the primary tanks 14.

Where a portion of the stored work is used to change a direction of travel of the primary tanks 14.

Where the displacement is then moved to the opposite tank repeating the process.

Where the remaining production is used to meet a consumer's need.

One disadvantage of known hydraulic balanced systems is that they are untimely, costly, degrading, unreliable energy production from current alternative energy sources and the added cost of energy storage.

This present technology solves those issues by a unique method and a unique process to use gravity as a continuous, affordable, long life and reliable energy generation system.

Two primary tanks 14 are moved inversely, one tank is lowered while the other tank is raised—resulting in unequal pressure between the commonly connected tanks displacement through a path via in part utilizing the production fluid 76.

As a result of the vertical movement of the primary tanks 14, one stationary displacement head pressure drops while the other increases.

The air/gas displacement in the top region of the primary tank 14 moves toward the low pressure through the common connection hose 28 of the gas displacements.

The volume transferred causes a pressure differential between the production cap and the tank fluid, resulting in buoyant lift. The buoyant lift can be converted through the production cylinder/ram 42 to do work and is captured in the accumulator 94 via the directional control valve 90.

The hydraulic production is directed through the directional control valve 90 and into the production accumulator 94 and used to power the hydraulically driven generator 98 via the motor 96.

In use with the hydraulically balance systems and means 112: When one of the primary tanks 14 is lowered, the weight of that tank creates hydraulic pressure in the lower hydraulic cylinder ram/shaft 114, while that pressure is increased by the hydraulic pump 126 by the electric drive motor 124 and directed by the control system/box 99.

At the end of the primary tanks 14 travel, the control system/box 99 reverses direction of the hydraulic cylinder rams/shafts 114. The control system/box 99 communicated with the directional control valve 90 and the consumer demand to modulate production and power generation.

In use with the buoyant or weight balanced system means 29: The production accumulator 94 can provide power to the drive cylinders 32 to cause the balanced tanks 14 to move vertically.

Counter balance of the present technology can be utilized to reduce weight change during movement. The ability to balance the tanks 14 directly affects the cost of moving the tanks vertically. The cost of the overall process is directly related to the cost of causing movement of balanced tanks 14.

It can be appreciated that the volume transferred, pressure differential between tanks 14, production and reset of the process are all secondary actions of movement of the tanks 14, moving the tanks therefore is the primary cost. The ability to counterbalance the tanks 14, while a secondary work is being performed inside the tanks 14, which is the production rams 42, is comparable to eliminating the prime mover cost.

It can further be appreciated that no simple system can isolate the primary cost or initial input energy because no secondary system, which described herewith of the uniqueness in interface and interaction, meaning systems must be combined to cause this effect and process—simple systems combined is called complex systems.

Orientation can be implied as method to cause pressure difference between tanks 14. Where the action of the tanks 14 moving changes the pressure between the two production platforms/rams 42. Where the displacement moves to the lower pressure. Where lowering pressure cause the work (normally the higher pressure does the work). Where a differential is the cause of the work—not a consumption of the pressure.

It can be noted that normally in a buoyancy design pressure is caused by pumping new pressure greater than the systems head pressure to cause a displacement. In present technology case, the combined action of the fluids changing pressures in relation to the fixed pedestals 80 creates the displacement by lowering the pressure where the displacement is desired. So the present technology uniquely creates displacement by lowering the pressure, the reason so is that the displacement movement is secondary. Again, only in a complex system is this possible.

The present technology can utilize a method to lift and sink the primary tanks 14. Where the volume of the displacement is amplified by the static displacer. The static displacer allows for buoyant lift equal to the sum of the displacer and displacement. Where the displacer volume reduces the volume required to transfer, and consequently reduces the time and thus speed of operation.

It can be appreciated that the present technology can utilize a buoyancy method that uses a “filler” to reduce the volume needed to read a differential pressure, this means the volume to start stroking a large load is dramatically reduced, and conversely sinking is also imitated with the release/removal of a small volume.

Another aspect is that the present technology can include interface or isolation of forces. Where the production systems and the buoyant work is isolated from the tanks 14. Where the opposite and equal reaction is diverted through the non-tank attached pedestal 80.

It can be appreciated that if the production system/rams 42 were attached to the tanks 14, then the tanks 14 would receive the opposite reaction to the buoyant work. Meaning the weight of the tanks 14 would change during the transfer of the displacement, and if that happened then the cost of operation would be equal to the work performed. The production would no longer be a secondary action.

To disconnect the downward or upward force from the tanks 14, the displacement unit 54 cannot be mounted to the tank 14 (makes the tank lighter), and you cannot push against the bottom (makes the tank heavier). If the tank is made lighter or heavier then the weight required counterbalance is removed.

Some advantages of the present technology can be, but limited to: The primary cost of a ‘work from gravity’ is normally the cost to reset the potential. In simple systems that cost of lifting a load or sinking a buoyant object is directly connected to the production and therefore directly proportional to the value of the potential.

The present technology is unique because it isolated the cost of lifting the load from the work performed by gravity. The present technology process is unique because “work must be removed” from the system to continue operation. The present technology process is further unique because the process interacts with the force of gravity to do work, and has no cost or effect on gravity.

The present technology's unique ability to combine multiple simple processes that work together result in effect as a controlled singular force able to do work on demand is a unique and unexpected result.

The design and intention of isolating the opposite force is unique. The opposite force is isolated by mounting the buoyant process outside the fluid detached from the fluid containing tank. This allows the immovable “ground” to absorb the counter force of buoyancy, with this interface of simple systems isolates tanks weights from the buoyancy process.

The tanks 14 can be counter balanced so that movement vertically is related to the cost of unbalancing (which includes friction). With the tanks 14 isolated from the force change during work and reset, the tanks remain the same weight throughout the entire process: movement, transfer of displacement, during work, and during reset of the work process.

When the tanks 14 orientations are changed vertically in relationship to each other and with the displacement being common to both (through connective plumbing), the displacement between the systems of the present technology creates a pressure differential, which the present technology converts to work. Therefore, while the displacement volume moves toward the lower pressure, work is performed.

It is the when that volume and differential pressure acts upon the present technology and the buoyant force exceeds the hydraulic resistance within the accumulator, that buoyant work is captured by the hydraulic cylinder and that production is directed to the accumulator.

Part of the hydraulic production is used to cause the tanks to move again, and the excess production is directed to the hydraulic driven generator.

It can be appreciated that a basic operation of the present technology can include:

Counter Balance—to reduce work involved in movement.

Orientate—to alternate pressure.

Present Technology Effect—to capture buoyant work with disproportional displacement.

Interface with base—to isolate buoyant force from tank.

Separate functions can include:

Movement of tanks with inverse pressure change.

Displacement Transfer including differential—Up/differential—down.

Lift into production including hydraulic production and hydraulic refill.

Storage of production powers electric generation and/or powers movement of tanks.

Production into electricity including system regulation and/or consumer demand.

Additional advantages and/or aspects of the present technology can include: A system to capture independent buoyant work. Counter balance primary work. Capture secondary work, with capturing of full primary work and secondary is presumed a loss. Generate work from buoyancy and gravity. Negate equal input work.

Additional advantages and/or aspects of counter balance drive system of the present technology can include: The cost of operation is reduced to friction and balance and secondary work adds no cost. Cancel out primary work. Eliminating pumping requirement. Inverse tank travel around fixed displacements.

The method of the present technology can alter the pressure between fixed displacements resulting in air transfer between tanks and work performed.

Inverse pressure change can be advantageous because the process lowers the pressure on the receiving tank while increasing the pressure on the sending tank by reference to the tank head to the externally fixed displacement.

Normally pressure is increased by force added, not altering references.

Lateral transfer displacement, normally to create buoyancy a displacement is pushed down into a fluid, and this process creates a reciprocal lateral transfer. This can be advantageous because pressure equalization caused by gravity is the secondary driving force.

Negate Internal Counter Forces by internal displacement mounted externally. This can be advantageous because a displacement creates both an upward force and a down force which is normally associated with the containment.

While embodiments of the buoyant counterbalance system and method for using same have been described in detail, it should be apparent that modifications and variations thereto are possible, all of which fall within the true spirit and scope of the present technology. With respect to the above description then, it is to be realized that the optimum dimensional relationships for the parts of the present technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present technology. For example, any suitable sturdy material may be used instead of the above-described.

Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology.

What is claimed as being new and desired to be protected by Letters Patent of the United States is as follows:

1. A fluid counterbalance system comprising:
a first unit comprising:
a first tank having a top wall, a bottom wall and a sidewall;
a first production ram slidably receivable in the first tank, the first production ram including a top wall, an open bottom and a sidewall;
a first displacement member in a fixed position in relation to the first tank and the first production ram, the first displacement member being located in the first production ram, the first displacement member defining a first channel including a first piston, and a second channel offset from the first channel and in communication with an interior of the first production ram;
a second unit comprising:
a second tank having a top wall, a bottom wall and a sidewall;
a second production ram slidably receivable in the second tank, the second production ram including a top wall, an open bottom and a sidewall;
a second displacement member in a fixed position in relation to the second tank and the second production ram, the second displacement member being located in the second production ram, the second displacement member defining a first channel including a second piston, and a second channel offset from the first channel and in communication with an interior of the second production ram;
a hollow pedestal connected to the first displacement member and the second displacement member, the hollow pedestal being configured to communicate a fluid between the interior of the first production ram and the interior of the second production ram; and
a production line connected to a first side of the first piston and a first side of the second piston.

2. The fluid counterbalance system according to claim 1, wherein the first tank and the second tank each include a fluid driven cylinder configured to raise or lower the first tank and the second tank, respectively.

3. The fluid counterbalance system according to claim 2 further comprising a directional control valve.

4. The fluid counterbalance system according to claim 3, wherein the fluid drive cylinder of the first tank and the second tank are connected to the directional control valve.

5. The fluid counterbalance system according to claim 3 further comprising a fluid reservoir connected to the directional control valve.

6. The fluid counterbalance system according to claim 3 further comprising an accumulator connected to the directional control valve.

7. The fluid counterbalance system according to claim 3 further comprising a fluid motor configured to receive fluid from the directional control valve.

8. The fluid counterbalance system according to claim 7 further comprising an electric generator connected to the fluid motor.

9. The fluid counterbalance system according to claim 3 further comprising a first displacement conduit configured to communicate a displacement fluid to or from the first piston, and a second displacement conduit configured to communicate the displacement fluid to or from the second piston by way of the directional control valve, wherein at least a part of the first and second displacement conduits are provided in the hollow pedestal.

10. The fluid counterbalance system according to claim 1, wherein the first and second units each include a fluid filled counter balance tank including a buoyant float slidably received therein and connected to the first tank and the second tank, respectively.

11. The fluid counterbalance system according to claim 1, wherein the first and second units each include counterbalance fluid driven cylinder and piston assembly configured to opposingly raise or lower the first and second units, respectively, by way of a shared counterbalance fluid.

12. The fluid counterbalance system according to claim 11 further comprising a connection line connecting a first end of each of the counterbalance fluid driven cylinder and piston assemblies to each other.

13. The fluid counterbalance system according to claim 12 further comprising a pump connected to the connection line.

14. The fluid counterbalance system according to claim 1 further comprising an air connection conduit attached to the top wall of the first and second tanks, the air connection conduit being configured to communicate any air or gas between an upper zone of the first and second tanks.

15. A fluid counterbalance system comprising:
a first unit comprising:
a first tank configured to be vertically moveable;
a first production ram slidably receivable in the first tank, the first production ram including a top wall, an open bottom, a sidewall and a first production piston;
a first displacement member in a fixed position in relation to the first tank and the first production ram, the first displacement member being located in the first production ram, the first displacement member including a first production cylinder configured to slidably receive the first production piston to vertically move the first production ram when a displacement fluid is provided thereto or removed therefrom by way of a first production line;
a second unit comprising:
a second tank configured to be vertically moveable;
a second production ram slidably receivable in the second tank, the second production ram including a top wall, an open bottom, a sidewall and a second production piston;
a second displacement member in a fixed position in relation to the second tank and the second production ram, the second displacement member being located in the second production ram, the second displacement member including a second production cylinder configured to slidably receive the second production piston to vertically move the second production ram when the displacement fluid is provided thereto or removed therefrom by way of a second production line;
a hollow pedestal connected to the first displacement member and the second displacement member, the hollow pedestal being configured to communicate a production fluid between an interior of the first production ram and an interior of the second production ram;
a directional control valve configured to control the displacement fluid to or from the first production cylinder, and the second production cylinder; and
a counterbalance assembly located below each of the first and second tanks, and configured to opposingly raise or lower the first and second tanks, respectively.

16. The fluid counterbalance system according to claim 15, wherein the directional control valve is connected with and configured to provide or receive the displacement fluid to or from a fluid reservoir, an accumulator connected, and a fluid motor connected to an electric generator.

17. The fluid counterbalance system according to claim 15 further comprising a first displacement conduit configured to communicate the displacement fluid to or from the first production cylinder, and a second displacement conduit configured to communicate the displacement fluid to or from the second cylinder by way of the directional control valve, wherein at least a part of the first and second displacement conduits are provided in the hollow pedestal.

18. The fluid counterbalance system according to claim 15, wherein the counterbalance assembly is a fluid filled counter balance tank including a buoyant float slidably received therein and connected to the first tank and the second tank, respectively, and further comprising a first actuator configured to raise or lower the first tank and a second actuator configured to raise or lower the second tank, wherein the first and second actuators being controlled by communication of the displacement fluid controlled from the directional control valve.

19. The fluid counterbalance system according to claim 15, wherein the counterbalance assembly is a pair of counterbalance cylinder and piston assemblies configured to opposingly raise or lower by a pump connected to a connection line connecting the pair of counterbalance cylinder and piston assemblies to each other.

20. A method of using a fluid counterbalance system, the method comprising the steps of:
a) creating a height displacement and a pressure difference between a first tank and a second tank by alternating lowering the first tank and raising the second tank that is directly based on movement of the first tank;
b) moving a first production ram about a first displacement member in a fixed position in the first tank, and moving a second production ram about a second displacement member in a fixed position in the second tank in a direction opposite to that of the first production ram by transferring a fluid between an interior of the first production ram and an interior of the second production ram, the first and second displacement members being in a fixed position by a hollow pedestal attached thereto, and the fluid is transferred between the first and second production rams by way of the hollow pedestal;
c) remaining the first tank and the second tank in an unbalanced condition; and
d) providing a first counterbalance to the first tank and a second counter balance to the second tank that is opposite to the first counterbalance.
